(19) United States
(12) Patent Application Publication
(10) Pub. No.: US 2012/0251964 A1
(43) Pub. Date: Oct. 4, 2012

(54) METHOD AND APPARATUS FOR SELECTIVE SUBSTRATE SUPPORT AND ALIGNMENT IN A THERMAL TREATMENT CHAMBER

(75) Inventors: MAKOTO INAGAWA, Palo Alto, CA (US); Shinichi Kurita, San Jose, CA (US)

(73) Assignee: APPLIED MATERIALS, INC., Santa Clara, CA (US)

(21) Appl. No.: 13/284,815

(22) Filed: Oct. 28, 2011

Related U.S. Application Data
(60) Provisional application No. 61/470,772, filed on Apr. 1, 2011.

(51) Int. Cl. F27D 3/12; F27D 3/00

(52) U.S. Cl. 432/11; 269/55

(57) ABSTRACT

The present invention generally relates to methods and apparatus for handling of substrates in a thermal treatment chamber. In one embodiment, an apparatus is provided. The apparatus includes a chamber body having sidewalls, a substrate support assembly disposed in the chamber body, the substrate support assembly movable in a first direction within the chamber body, and two or more support fingers coupled to the sidewalls, the two or more support fingers being movable in a second direction within the chamber body, the second direction being transverse to the first direction.

### CROSS-REFERENCE TO RELATED APPLICATIONS

This application claims benefit of U.S. Provisional Patent Application Ser. No. 61/470,772 (APPM 16306L), filed Apr. 1, 2011, which is hereby incorporated by reference herein.

### BACKGROUND OF THE INVENTION

1. Field of the Invention

Embodiments of the present invention generally relate to methods and apparatus for handling of substrates in a thermal treatment chamber, such as an annealing chamber that processes large area flat media, such as large area substrates.

2. Description of the Related Art

Flat media, such as rectangular, flexible sheets of glass, plastic, silicon, ceramic, or other material, is typically used in the manufacture of flat panel displays, solar devices, among other applications. Materials to form electronic devices, films and other structures on the flat media are deposited onto the flat media by numerous processes. Typically, thermal processes are performed on the substrate prior to or after deposition in a thermal treatment chamber.

In each of these processes the substrate is typically supported in a planar orientation on a substrate support with a relatively flat substrate supporting surface within the thermal treatment chamber. Some of these substrate supports may include a heater to heat the substrate. When a heated substrate support is utilized, conductive heat transfer is greatest where the substrate is in contact with the substrate support.

However, when the substrate is to be transferred, the substrate must be spaced away from the substrate supporting surface to allow a robot blade to access the underside of the substrate. While some conventional substrate supports utilize a plurality of support structures, such as pins, that space the substrate from the substrate support, the pins may not be desirable for certain chamber configurations based on design rules and/or footprint considerations. Further, support pins are sometimes fixed relative to the substrate supporting surface to space the substrate away from the substrate supporting surface, which facilitates transfer of the substrate. However, in such designs, the substrate is not in contact with the heated substrate supporting surface. This affects heating efficiency which may reduce throughput.

Additionally, substrates may be misaligned during transfer. The misalignment of substrates may cause collisions which may damage the substrate. Conventional chambers may be equipped with sensors to detect this misalignment and prevent collisions by stopping transfer prior to a collision. Some conventional systems may include a peripheral support chamber having alignment means to correct substrate misalignment. However, stopping substrate transfer and/or aligning a substrate in a peripheral support chamber takes considerable time, which undesirably decreases throughput.

Therefore, there is a need in the art for an apparatus and method for enabling substrate support and alignment in a thermal treatment chamber.

### SUMMARY OF THE INVENTION

The present invention generally relates to methods and apparatus for handling of substrates in a thermal treatment chamber. In one embodiment, an apparatus is provided. The apparatus includes a chamber body having sidewalls, a substrate support assembly disposed in the chamber body, the substrate support assembly movable in a first direction within the chamber body, and two or more support fingers coupled to the sidewalls, the two or more support fingers being movable in a second direction within the chamber body, the second direction being transverse to the first direction.

In another embodiment, an apparatus is provided that includes a chamber body, a substrate support assembly disposed in the chamber body, the substrate support assembly movable in a first direction within the chamber body, and two or more support structures disposed in the chamber body, the two or more support structures being movable in a second direction within the chamber body, the second direction being transverse to the first direction.

In another embodiment, a method for processing a substrate is provided. The method includes inserting a robot blade having a substrate thereon into a chamber, and transferring the substrate to a plurality of support structures within the chamber, each of the support structures being coupled to interior walls of the chamber. The method further includes retracting the robot blade from the chamber, and transferring the substrate from the support structures to a heating plate within the chamber.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A is a cross-sectional view of a thermal treatment chamber.

FIG. 1B is a cross-sectional view of the thermal treatment chamber of FIG. 1A.

FIG. 2 is an isometric view of a portion of the thermal treatment chamber of FIGS. 1A and 1B.

FIG. 3A is an isometric view of one embodiment of a support structure that may be utilized in the thermal treatment chamber of FIG. 2.

FIG. 3B is an isometric view of another embodiment of a support structure that may be utilized in the thermal treatment chamber of FIG. 2.

FIG. 3C is an enlarged isometric view of a distal end of the support fingers of the support structure shown in FIG. 3A.

FIGS. 4A-4D are isometric views showing a substrate alignment sequence utilizing the roller assembly of FIG. 3C.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present invention generally relates to methods and apparatus for handling of substrates in a thermal treatment chamber. The thermal treatment chamber is exemplarily described herein as an annealing chamber, but the invention may be applicable to other thermal treatment and vacuum processing chambers, such as a chemical vapor deposition (CVD) chamber, a physical vapor deposition (PVD) chamber, an etch chamber, or any other chamber utilized in heating of substrates or processing substrates at elevated temperatures.

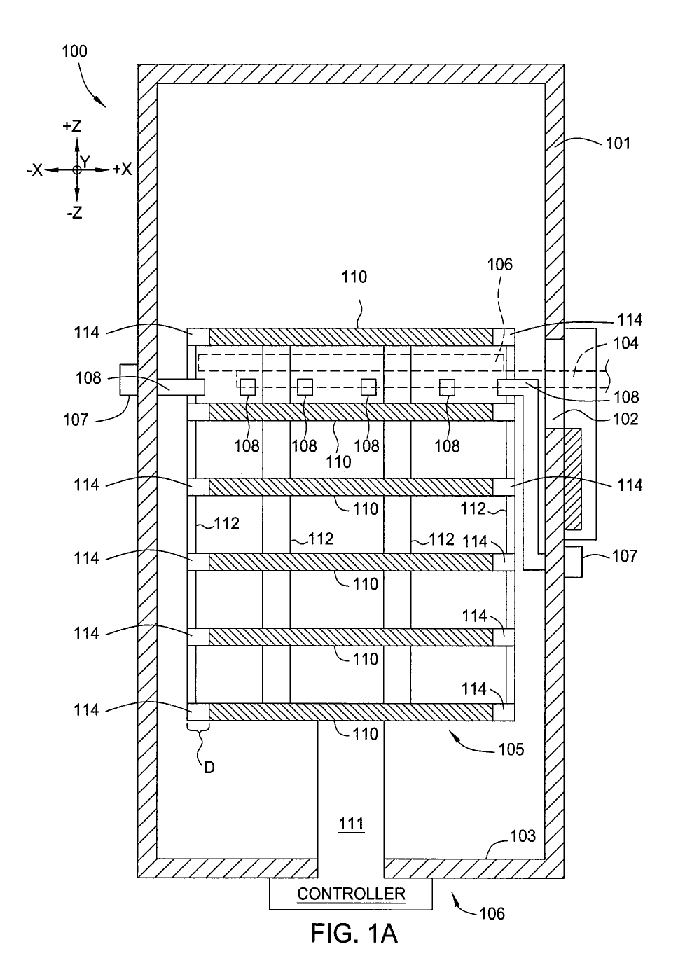

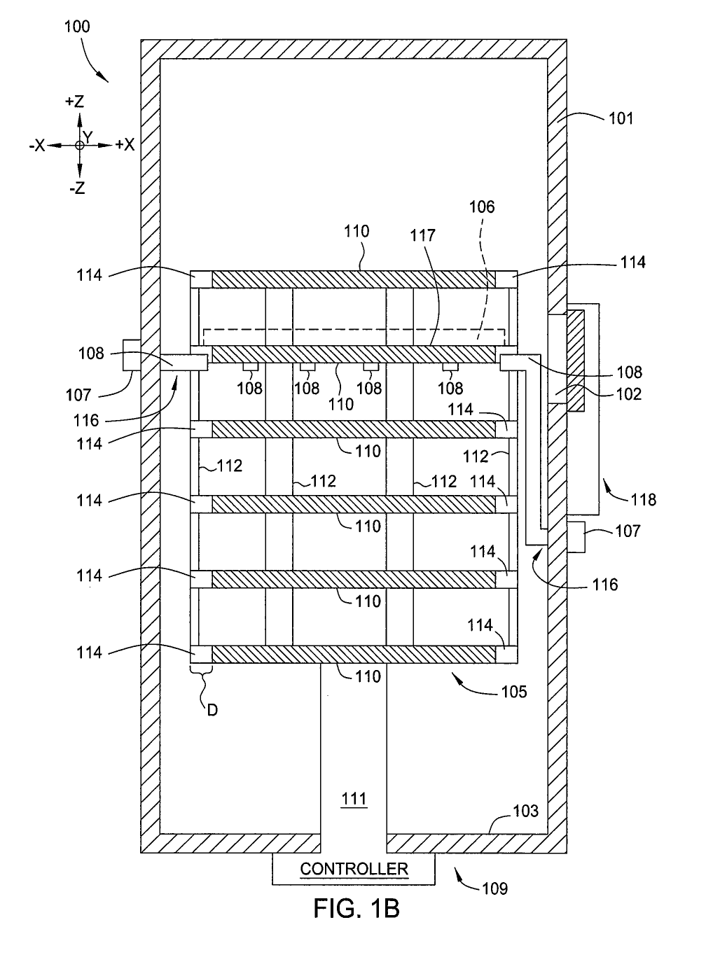

FIG. 1A is a cross-sectional view of a thermal treatment chamber 100 that may be utilized for heating multiple substrates, for example in an annealing process. The thermal treatment chamber 100 comprises a chamber body 101 having a bottom 103 and a slit valve opening 102. The slit valve opening 102 is formed through a sidewall of the chamber body 101 to permit an end effector 104 (shown in phantom) to enter and exit the thermal treatment chamber 100 and deliver or retrieve a substrate 106 (also shown in phantom) from a substrate support assembly 105. The substrate support assembly 105 is coupled to an elevator mechanism 109 having a shaft 111 disposed through the bottom 103 of the chamber body 101. The elevator mechanism raises and lowers the substrate support assembly 105 in the Z direction relative to the slit valve opening 102. The substrate support assembly 105 comprises a plurality of heating plate structures 110. The heating plate structures 110 are coupled together by one or more supporting bars 112 that maintain the heating plate structures 110 in a fixed position relative to an adjacent heating plate structure 110. In one embodiment, the heating plate structures 110 are spaced about 90 mm to about 110 mm apart. The supporting bars 112 are disposed at various locations along the perimeter of the heating plate structures 110. The supporting bars 112 are spaced along the perimeter of the heating plate structures 110 to allow passage of a plurality of support fingers 108 as further described below. The substrate support assembly 105, which includes all of the heating plate structures 110 and the supporting bars 112, move as a single structure within the thermal treatment chamber 100.

The support fingers 108 are coupled to actuators 107. The actuators 107 move the support fingers 108 in at least a lateral direction (e.g., at a transverse non-zero angle relative to the Z direction, for example in at least one of the X and Y directions) relative to the longitudinal axis of the chamber body 101 to control the extension distance of the support fingers 108 relative to the chamber body 101. The transverse angle includes any non-zero angle of the plane of the support fingers 108 relative to the travel direction of the substrate support assembly 105 (e.g., Z direction). The transverse angle may include an angle of about 45 degrees to about 90 degrees (from horizontal) relative to the travel direction of the substrate support assembly 105. In FIG. 1A, the support fingers 108 are extended a distance from opposite sides of the chamber body 101 to a position inward of the periphery of the substrate 106. The support fingers 108 may extend inward past an edge of the substrate 106 or outward to be spaced away from the edge of the substrate 106. During substrate transfer, the support fingers 108 extend to a position to support an edge region of the substrate 106. In one embodiment, the edge region of the substrate 106 that is contacted by the support fingers 108 during transfer is about 6 mm to about 15 mm from the edge of the substrate 106. In other embodiments, the edge region is about 10 mm to about 12 mm.

Each of the heating plate structures 110 include slots 114 formed therein to allow passage of the support fingers 108 when the substrate support assembly 105 is moved vertically. The distance that each of the support fingers 108 extend inwardly from the chamber body 101 is commensurate with a depth D of each of the slots 114 to allow passage of a distal end (i.e., innermost end) of the support fingers 108 when the heating plate structure 110 is moved therepast. In one embodiment, the depth D of each of the slots 114 may be about 10 mm to about 25 mm, such as about 20 mm. In one example, the inward extension of the support fingers 108 during transfer may be about 12 mm past the edge of the substrate 106. Thus, when the depth D of the slots 114 is about 20 mm, the support fingers 108 extend into about 60 percent (%) of the depth D of the slots 114. This provides ample clearance between the slots 114 and the support fingers 108 during transfer (i.e., about 40% of the depth D). Other support finger 108 and depth D transfer relationships are contemplated, such as about 50% to about 10% clearance of the depth D. However, the distance that the support fingers 108 extend from the chamber body 101 may be controlled by the actuators 107 to extend inwardly beyond the depth D when desired, and retract outwardly towards the chamber body 101 in order to interface with the slots 114 and/or remain clear of the slots 114 and the heating plate structures 110 during movement of the heating plate structures 110 past the support fingers 108.

To deliver the substrate 106 into the thermal treatment chamber 100, the end effector 104 extends through the slit valve opening 102 and then lowers in a vertical direction (−Z direction). As the end effector 104 lowers, so does the substrate 106 supported thereon. However, as the substrate 106 lowers, the substrate 106 comes to rest on the support fingers 108. Once the substrate 106 is completely supported by the support fingers 108 and clear of the end effector 104, the end effector 104 retracts from the thermal treatment chamber 100 through the slit valve opening 102 in a lateral direction (+X direction).

When the substrate 106 is supported on the support fingers 108 and the end effector 104 is retracted from the thermal treatment chamber 100, the substrate support assembly 105 may be actuated vertically (+Z direction). Movement of the substrate support assembly 105 vertically moves a heating plate structure 110 toward a lower surface of the substrate 106. Each of the support fingers 108 pass through a respective slot 114 while the continued vertical movement of the substrate support assembly 105 allows the substrate 106 to be lifted from the support fingers 108 and supported by the heating plate structure 110 as shown in FIG. 1B.

FIG. 1B is a cross-sectional view of the thermal treatment chamber 100 of FIG. 1A. The substrate 106 is shown supported by an upper surface 117 of the heating plate structure 110. A thermal treatment process may be performed on the substrate 106 when it is in contact with the heating plate structure 110. The upper surface 117 of the heating plate structure 110 is a planar surface and includes no pins or other intervening structures between the substrate 106 and the upper surface 117. The substrate 106 may lie flat on the upper surface 117 of the heating plate structure 110 to ensure good conductive heat transfer between the substrate 106 and the upper surface 117. Thus, conductive heat transfer from the heating plate structure 110 is optimized due to the enhanced contact between the substrate 106 and the heating plate structure 110. The thermal treatment process performed on the substrate 106 may be an annealing process. As shown in FIG. 1A, six heating plate structures 110 are present. It is to be understood that more or less heating plate structures 110 may be present. Other substrates (not shown) may be transferred to empty heating plate structures 110 for thermal treatment as described above. Once one or more substrates are transferred to the substrate support assembly 105, the thermal treatment chamber 100 may be sealed by closing a slit valve door, and the substrates may be prepared for the thermal treatment process, such as an annealing process. In this position, the substrate 106 is in direct contact with the heating plate structure 110.

Each of the support fingers 108 are coupled to a support structure 116. Each of the support structures 116 may include one or more structural members comprising a one or a combination of a shaft, a bar or a rod coupled together with fasteners, welds, adhesive bonding or other fastening methods. Each of the support structures 116 may be made of a process resistant material, such as aluminum, stainless steel, a ceramic material, and combinations thereof. The support structures 116 may be substantially coplanar as shown with the support structure 116 opposite the slit valve opening 102 or offset as shown with the support structure 116 adjacent the slit valve opening 102. The offset support structure 116 is utilized to allow the support fingers 108 adjacent the slit valve opening 102 to operate without blocking the slit valve opening 102. The actuators 107 associated with the support structure 116 adjacent the slit valve opening 102 may be coupled to the chamber body 101 at a location that does not interfere with a slit valve actuator assembly 118 disposed outside of the chamber body 101.

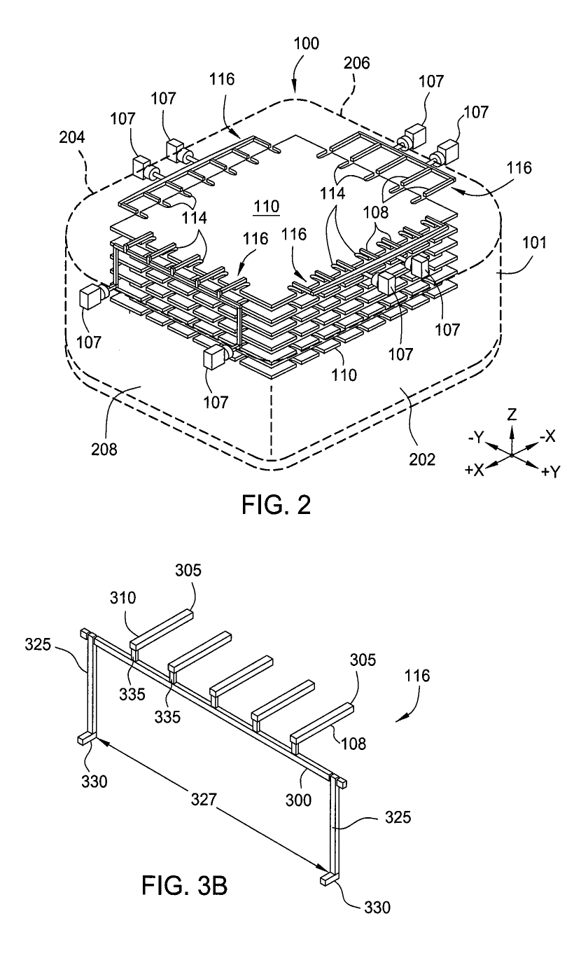

FIG. 2 is an isometric view of a portion of the thermal treatment chamber 100 of FIGS. 1A and 1B. The supporting bars 112 are not shown in FIG. 2 and the chamber body 101 is at least partially shown in phantom to show the configuration of the support fingers 108 and the heating plate structures 110. As shown, each of the support fingers 108 of the support structures 116 are substantially aligned with the slots 114 in the heating plate structure 110 such that the support fingers 108 may interleave with the slots 114 to allow unimpeded vertical movement of the substrate support assembly 105 as described above. Slots 114 in additional heating plate structures 110 below the uppermost heating plate structure 110 may be substantially aligned with the support fingers 108 and each other.

The chamber body 101 comprises sidewalls 202, 204, 206 and 208. In this Figure, sidewall 208 includes the slit valve opening 102 (shown in FIGS. 1A and 1B). The one or more actuators 107 may be coupled to each support structure 116 through at least two opposing sidewalls 202, 204, 206 and 208 of the chamber body 101. Here, one or more actuators 107 are coupled to the support structures 116 through each sidewall 202, 204, 206 and 208. In the embodiment shown in FIG. 2, the actuators 107 disposed on the opposing sidewalls 206 and 208 control movement of the support structures 116 coupled thereto in the X direction. The actuators 107 disposed on the opposing sidewalls 202 and 204 control movement of the support structures 116 coupled thereto in the Y direction. The actuators 107 may operate independently or in unison to move the respective support structure 116 coupled thereto. In one aspect, the actuators 107 that are coupled to a common support structure 116 may operate in synchronization while the actuators coupled to different support structures 116 may operate independently. The actuators 107 may move the support fingers 108 inward to a position past the innermost surface of the slots 114 or outward to a position outside of the perimeter and clear of the heating plate structure 110.

The support structures 116 may have the same number of support fingers 108 or a different number of support fingers 108 depending on the size of a substrate (not shown). In the embodiment shown, the support structures 116 associated with the sidewalls 206 and 208 include 5 support fingers 108 while the support structures 116 associated with the sidewalls 202 and 204 include 7 support fingers 108. Depending on the length and width dimensions of the substrate (not shown), the support structures 116 may be longer or shorter than adjacent support structures 116. In the embodiment shown, the support structures 116 associated with the sidewalls 206 and 208 include a length that is less than a length of the support structures 116 associated with the sidewalls 202 and 204. The spacing of the support fingers 108 on each support structure 116 may be the same or different. Depending on the size of the substrate (not shown), the pitch of the support fingers 108 may be between about 180 mm to about 225 mm.

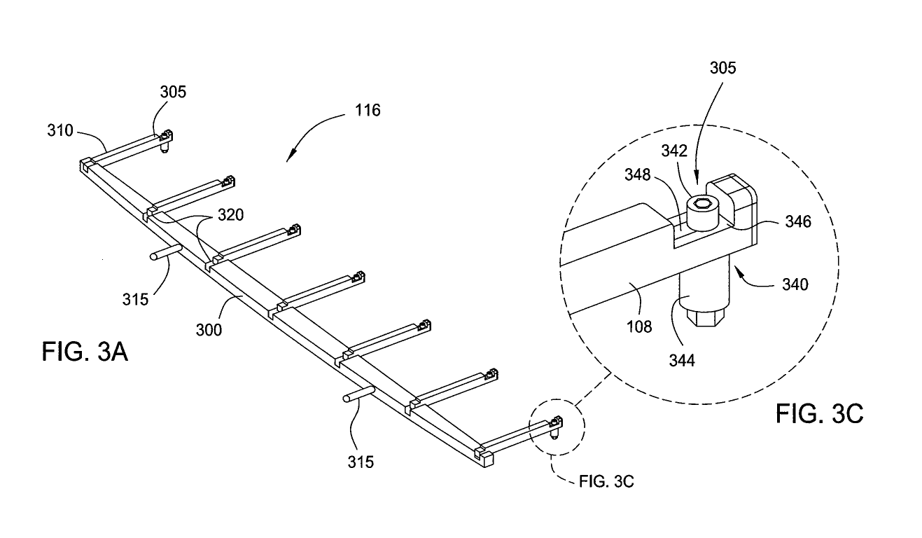

FIG. 3A is an isometric view of one embodiment of a support structure 116 that may be utilized in the thermal treatment chamber 100 of FIG. 2. The support structure 116 includes a crossbar 300 having the support fingers 108 coupled thereto. The support fingers 108 have a distal end 305 that supports a substrate (not shown) and a proximal end 310 opposite the distal end 305. The crossbar 300 may also include an actuator coupling structure 315. The actuator coupling structure 315 is an attachment point for the actuator 107 (shown in FIG. 2). The actuator coupling structure 315 includes a shaft or bar extending therefrom. In another embodiment (not shown), the actuator coupling structure 315 may include a hole formed in the crossbar 300. The hole may be smooth or threaded to facilitate coupling with an actuator shaft.

The support structure 116 is made of materials that withstand high processing temperatures, and possess sufficient rigidity and physical properties to support a substrate. In one example, the crossbar 300 and the support fingers 108 are fabricated from a ceramic material, such as silicon carbide (SiC). The proximal end 310 is coupled to the crossbar 300 by fasteners, such as bolts or screws, welding, adhesives or other fastening method. The support fingers 108 may be disposed in grooves 320 formed in the crossbar 300. The grooves 320 may be utilized to facilitate alignment of the support fingers 108 relative to the crossbar 300. Each of the support fingers 108 may be bolted to the crossbar 300 by ceramic fasteners, such as a ceramic bolt and nut.

FIG. 3B is an isometric view of another embodiment of a support structure 116 that may be utilized in the thermal treatment chamber 100 of FIG. 2. The support structure 116 shown may be utilized on the sidewall 208 of the thermal treatment chamber 100 of FIG. 2. The support structure 116 includes a crossbar 300 coupled to two support struts 325. A space 327 between the support struts 325 is sized to allow a substrate to pass therebetween. The support struts 325 may be coupled to the crossbar 300 at one end and have a first extended member 330 at another end. The first extended member 330 may be configured as an actuator coupling structure as described in FIG. 3A. The first extended member 330 may be parallel with the plane of the support fingers 108. A second extended member 335 may be disposed between the crossbar 300 and the proximal end 310 of the support fingers 108. Each of the second extended members 335 may be positioned at a non-zero angle relative to the plane of the support fingers 108, such as substantially orthogonal to the plane of the support fingers 108, and coplanar with the support struts 325. Each of the crossbar 300, the support struts 325, and the support fingers 108, as well as the first extended member 330 and the second extended member 335 may be fabricated from a ceramic material, such as SiC.

FIG. 3C is an enlarged isometric view of a distal end 305 of the support fingers 108 of the support structure 116 shown in FIG. 3A. The distal end 305 includes a roller assembly 340 utilized to facilitate substrate alignment. The roller assembly 340 includes a fastener 342 and a tubular member 344 disposed at least partially around the fastener 342. The roller assembly 340 may be disposed in a recess 346 formed in the distal end 305 of the support finger 108. The fastener 342 of the roller assembly 340 may be disposed in a slot 348 formed in the distal end 305 of the support finger 108. The slot 348 facilitates adjustment of the roller assembly 340 relative to the distal end 305 of the support finger 108. The roller assembly 340 may be made of a ceramic material, such as SiC.

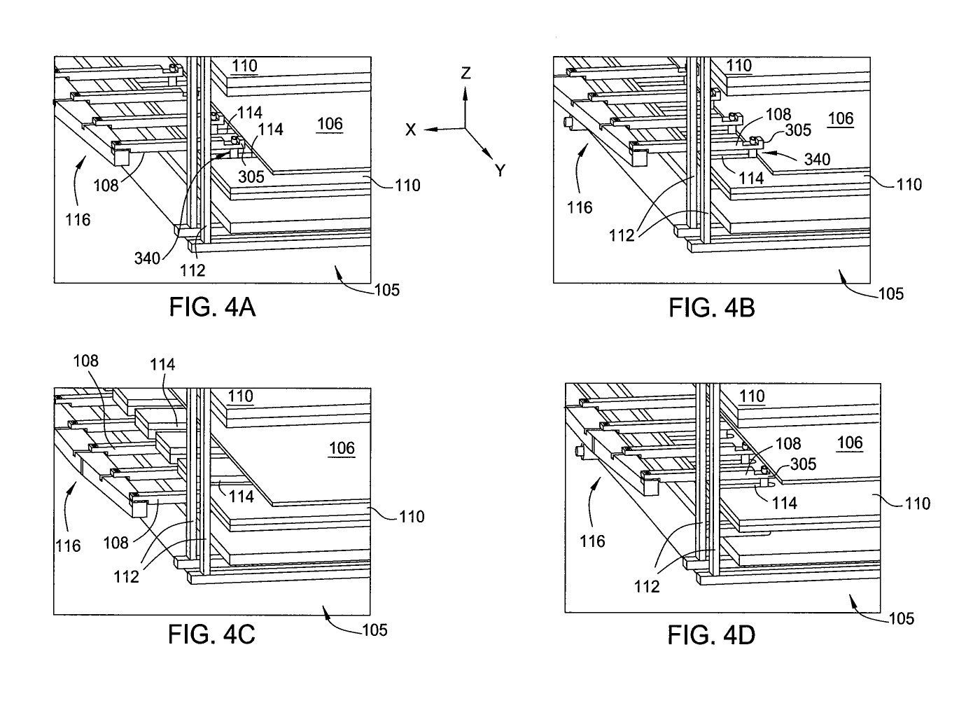

FIGS. 4A-4D are isometric views showing a substrate alignment sequence utilizing the roller assembly 340 of FIG. 3C. The exemplary sequence is described showing a substrate 106 disposed on a heating plate structure 110. The alignment sequence may be performed during heating of the substrate 106 by the heating plate structure 110, for example in an annealing process. Alignment processes occurring during heating of the substrate 106 may increase throughput as the substrate 106 is sufficiently aligned prior to transfer out of the chamber body 101. However, alignment of the substrate 106 may be performed during transfer of the substrate 106 (i.e., while the substrate 106 is disposed on a robot blade).

FIG. 4A shows the support structure 116 and the support fingers 108 retracted relative to the substrate 106. In this position the substrate 106 may pass the distal end 305 of the support fingers 108. The substrate support assembly 105 is moved to a lowered position relative to the support fingers 108 without the support fingers 108 interfering with the substrate 106 or the heating plate structure 110. While not shown, an opposing support structure 116 may be moved to a position similar to the support structure 116 that is shown in FIG. 4A.

FIG. 4B shows the support fingers 108 being substantially parallel with the substrate 106. The substrate 106 is in a position where the roller assembly 340 may contact an edge of the substrate 106. The support structure 116 may be actuated inward (X direction) to engage the edge of the substrate 106. When the substrate 106 is diagonally misaligned relative to the heating plate structure 110, the outmost corner of the substrate 106 may be contacted by the roller assembly 340 first. The support structure 116 may be further actuated to move (i.e., push) the substrate 106 laterally and align the substrate 106. While not shown, an opposing support structure 116 may be moved to a similar position to allow a support finger 108 to push, contact and/or maintain the position of an opposing corner of the substrate 106. When a substrate 106 is laterally misaligned relative to the heating plate structure 110, the outmost edge of the substrate 106 may be contacted by a roller assembly 340 on one or more of the support fingers 108 first. The support structure 116 may be further actuated to move (i.e., push) the substrate 106 laterally and align the substrate 106. Proper alignment of the substrate 106 may be a position where at least two opposing edges of the substrate 106 are substantially equidistant from edges of the heating plate structure 110. While not shown, an opposing support structure 116 extending from an opposing side of the chamber body 101 may be moved similarly inward to allow one or more support fingers 108 to push, contact and/or maintain the position of an opposing edge of the substrate 106.

FIG. 4C shows the support structure 116 retracted away from the substrate 106, which is properly aligned as described above. The support fingers 108 are moved outwardly to a position where the substrate support assembly 105 may move upward (Z direction) without contact between the support fingers 108 and the substrate 106. The support fingers 108 may be retracted outwardly from the edge of the substrate 106 as the substrate support assembly 105 is raised without contact between the support fingers 108 and the substrate 106. Once the substrate support assembly 105 is raised so the lower surface of the substrate 106 is above the plane of the support fingers 108, the support fingers 108 may move inwardly (X direction) to a position the distal end 305 of the support fingers 108 below the substrate 106.

FIG. 4D shows the distal end 305 of the support fingers 108 engaged with the substrate 106. When the support fingers 108 are positioned as described in reference to FIG. 4C, the substrate support assembly 105 may be lowered (X direction) to allow the support fingers 108 to engage the substrate 106 and support the substrate 106 above the heating plate structure 110. In this position, a robot blade may be inserted below the substrate 106 and transfer the substrate 106 out of the chamber body.

The inventors have discovered that embodiments of the support structure 116 as described herein increases throughput and enables substrates to be transferred efficiently to and from a flat heating plate structure 110. The invention enables more efficient heating of substrates as support pins or other structures between the substrate and the surface of the heating plate structure 110 are not needed for transfer processes. Further, alignment of substrates within the thermal treatment chamber 100 provided by embodiments of the support fingers 108 increases throughput.

A thermal treatment chamber, such as the thermal treatment chamber 100 as described in FIGS. 1A and 1B has been tested. A substrate having dimensions of about 1300 mm×about 1500 mm, and a thickness of about 0.5 mm, was heated for about 8 minutes at about 500 degrees C. The substrate was supported at the edges by four support structures 116 as shown in FIG. 2 after the heating. The deflection (i.e., “sag”) of the substrate at the geometric center was less than about 18 mm, which was well within the allowable spacing to allow a robot blade to enter therebetween for transfer.

While the foregoing is directed to embodiments of the present invention, other and further embodiments of the invention may be devised without departing from the basic scope thereof, and the scope thereof is determined by the claims that follow.

1. An apparatus, comprising:
a chamber body having sidewalls;
a substrate support assembly disposed in the chamber body, the substrate support assembly movable in a first direction within the chamber body; and
two or more support fingers coupled to the sidewalls, the two or more support fingers being movable in a second direction within the chamber body, the second direction being transverse to the first direction.

2. The apparatus of claim 1, wherein each of the two or more support fingers are independently movable.

3. The apparatus of claim 1, wherein the two or more support fingers comprises at least two support fingers per sidewall of the chamber body.

4. The apparatus of claim 1, wherein the two or more support fingers are coupled to one or more support structures.

5. The apparatus of claim 4, wherein each of the one or more support structures are coupled to an actuator.

6. The apparatus of claim 5, wherein the one or more support structures comprises one support structure per sidewall of the chamber body.

7. The apparatus of claim 5, wherein each actuator is independently controlled.

8. The apparatus of claim 5, wherein at least one of the support structures is disposed in a plane that is offset from a plane of the other support structures.

9. The apparatus of claim 1, wherein a portion of the two or more support fingers comprise a roller assembly.

10. An apparatus, comprising:
a chamber body;
a substrate support assembly disposed in the chamber body, the substrate support assembly movable in a first direction within the chamber body; and
two or more support structures disposed in the chamber body, the two or more support structures being movable in a second direction within the chamber body, the second direction being transverse to the first direction.

11. The apparatus of claim 10, wherein each of the two or more support structures comprise a plurality of support fingers coupled thereto.

12. The apparatus of claim 11, wherein at least a portion of the plurality of support fingers comprise a roller assembly.

13. The apparatus of claim 10, wherein the two or more support structures surround a perimeter of the substrate support assembly.

14. The apparatus of claim 10, wherein each of the two or more support structures are coupled to an actuator.

15. The apparatus of claim 10, wherein each of the two or more support structures are independently movable.

16. A method for processing a substrate, comprising:
inserting a robot blade having a substrate thereon into a chamber;
transferring the substrate to a plurality of support structures within the chamber, each of the support structures being coupled to interior sidewalls of the chamber;
retracting the robot blade from the chamber; and
transferring the substrate from the support structures to a heating plate within the chamber.

17. The method of claim 16, wherein transferring the substrate from the robot blade comprises moving the robot blade in a vertical direction.

18. The method of claim 16, wherein transferring the substrate from the support structures comprises moving the heating plate in a vertical direction.

19. The method of claim 16, further comprising:
aligning the substrate relative to the heating plate.

20. The method of claim 19, wherein the aligning comprises contacting one or more edges of the substrate with one or more support fingers disposed on the plurality of support structures.
